(19) United States
(12) Patent Application Publication
(10) Pub. No.: US 2026/0024933 A1
(43) Pub. Date: Jan. 22, 2026

(54) HIGH-STABILITY ELECTRICAL CONNECTOR AND INTERCONNECTION SYSTEM THEREOF

(71) Applicant: Amphenol Aorora Technology (Huizhou) Co., Ltd., Huizhou (CN)

(72) Inventors: Qi Han, Huizhou (CN); Xiaohong Zhu, Huizhou (CN)

(73) Assignee: Amphenol Aorora Technology (Huizhou) Co., Ltd., Huizhou (CN)

(21) Appl. No.: 19/268,314

(22) Filed: Jul. 14, 2025

(30) Foreign Application Priority Data
Jul. 16, 2024 (CN) 202421687580.1

(51) Int. Cl. H01R 12/77; H01R 43/26

(52) U.S. Cl. CPC H01R 12/774; H01R 43/26

(57) ABSTRACT

High-stability electrical connector and interconnection system thereof are provided. An interconnection system includes a receptacle connector and a plug connector. The plug connector includes a latch and a connector position assurance (CPA) device together configured to secure the plug connector to the receptacle connector. The CPA device is configured to be movable to a locked position from a pre-locked position when the plug connector is properly mated with the receptacle connector. At the locked position, the CPA device prevents the latch of the plug connector from disengaging from the receptacle connector. The CPA device includes a body, cantilevers connected to body sides and configured to engage a feature of the plug connector, and elastic arms extending from the body front and configured to abut a feature of the receptacle connector. Techniques described herein enable reliable interconnections in a harsh environment such as one presented by an automobile.

### CROSS-REFERENCE TO RELATED APPLICATION

This application claims priority to and the benefit of Chinese Patent Application No. 202421687580.1, filed on Jul. 16, 2024. The contents of this application are incorporated herein by reference in their entirety.

### TECHNICAL FIELD

This application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors. In other systems, it may be impractical to join two printed circuit boards by directly mating connectors on those printed circuit boards. For example, when the system is assembled, those printed circuit boards may be separated by too great a distance for a direct connection between connectors mounted to the printed circuit boards.

In some systems, connections between electronic assemblies may be made through cables. The cables may be terminated with connectors that mate with connectors mounted on a printed circuit board. In this way, connections between electronic assemblies may be made by plugging a connector that is part of a cable assembly into a board connector that is mounted to the printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine control unit, transmission control unit (TCUs), battery management system (BMS), cell sensing circuit (CSC), security systems, emissions control system. lighting control units, advanced driver assistance systems (ADAS), entertainment systems, navigation systems, and cameras. These electronic control units may be manufactured as separate assemblies. To simplify manufacture of an automobile, the assemblies may be connected via cables that are terminated with connectors that enable connections to mating board connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures. In an automobile, any of a number of components might generate electromagnetic radiation, such as spark plugs, alternators or power switches. Noise can be particularly disruptive for high speed signals such as those use to communicate data over an automobile network.

### SUMMARY

Aspects of the present disclosure relate to high-stability electrical connectors and interconnection systems thereof.

Some embodiments relate to a connector position assurance (CPA) device for a plug connector. The CPA device may include a body comprising first and second sides opposite to each other, and a front joining the first and second sides; first and second cantilevers connected to the first and second sides of the body, respectively, the first and second cantilevers configured to engage a first feature of the plug connector; and first and second elastic arms extending from the front of the body and configured to abut a feature of a mating receptacle connector to the plug connector such that the CPA device prevents a latch of the plug connector from disengaging from the mating receptacle connector.

Optionally, each of the first and second elastic arms comprises a first interfacing portion configured to abut a second feature of the plug connector at a pre-locked position, and a second interfacing portion configured to abut the feature of the mating receptacle connector at a locked position.

Optionally, for each of the first and second elastic arms: the first interfacing portion is a recess recessing in a mating direction; and the second interfacing portion is a protrusion protruding in a direction perpendicular to the mating direction.

Optionally, the first cantilever comprises first and second ends respectively connected to the first side of the body; the second cantilever comprises third and fourth ends respectively connected to the second side of the body; and each of the first and second cantilevers comprises a protrusion protruding away from the body and configured to engage the first feature of the plug connector.

Some embodiments relate to a plug connector for terminating first and second flexible cables. The plug connector may include a housing comprising first and second rails, and the latch disposed between the first and second rails, each of the first and second rails comprising a pre-locking groove and a locking groove; and the CPA device described herein, the CPA device configured to be movable between a pre-locked position when engaging the pre-locking grooves of the first and second rails of the housing and a locked position when engaging the locking grooves of the locking grooves of the first and second rails of the housing.

Optionally, the latch comprises first and second resilient beams and a bridge connecting distal ends of the first and second resilient beams; and the CPA device is configured to abut against the bridge of the latch of the housing in the locked position.

Optionally, the housing comprises a protruding portion disposed between the first and second resilient beams of the latch of the housing and configured to be disposed below the feature of the mating receptacle connector.

Optionally, the protruding portion comprises a bulge configured to abut against the first and second elastic arms of the CPA device at the pre-locked position, and a hook configured to engage the body of the CPA device at the pre-locked position.

Optionally, each of the first and second elastic arms of the CPA device comprises an interfacing portion disposed adjacent the protruding portion of the housing.

Optionally, the first and second flexible cables comprise a flexible flat cable (FFC), and/or a flexible circuit board (FPC); and the housing comprises elastic members configured to snap into holes of the first and second flexible cables to pre-lock the first and second flexible cables.

Some embodiments relate to a receptacle connector. The receptacle connector may include a housing comprising a slot, a tongue portion disposed in the slot and separating the slot into an upper portion and a lower portion, and a feature disposed in the upper portion of the slot, the tongue portion comprising a plurality of chambers, and a plurality of conductive elements, each of the plurality of conductive elements comprising a base portion held by the housing, a mating beam extending from the base portion into a respective chamber of the tongue portion, and a contact tail extending from the base portion, the plurality of conductive elements comprising first terminals and second terminals disposed in alternative, each of the first terminals comprising two mating contact portions protruding into the upper portion of the slot, and each of the second terminals comprising two mating contact portions protruding into the lower portion of the slot.

Optionally, the feature is a pillar extending from a top wall of the housing towards the tongue portion of the housing.

Optionally, the top wall of the housing comprises first and second apertures disposed on opposite sides of the pillar and configured to engage hooks of a mating plug connector.

Optionally, the housing comprises first and second side walls connected by the top wall; each of the first and second side walls comprises a socket; and the receptacle connector comprises first and second board locks each disposed in the socket of a respective one of the first and second side walls of the housing.

Optionally, each of the first and second board locks comprises a contact tail extending beyond the respective socket; a bump adjacent the contact tail and engaging outer walls of the respective socket; and a plurality of barbs engaging inner walls of the respective socket.

Some embodiments relate to a method of operating a connector position assurance (CPA) device for securing a plug connector to a receptacle connector. The method may include providing the plug connector with the CPA device disposed in a pre-locked position on a plug housing, the plug housing comprising a latch with a pair of resilient beams and a bridge connecting distal ends of the pair of resilient beams, each of the pair of resilient beams comprising a hook protruding upwards; engaging the plug connector with the receptacle connector comprising disposing the hooks of the pair of resilient beams into apertures of a top wall of a receptacle housing; and moving the CPA device from the pre-locked position to a locked position comprising pressing a pair of elastic arms of the CPA device against a feature of the receptacle housing.

Optionally, the plug housing comprises a pair of rails disposed on opposite sides of the latch; each of the pair of rails comprises a pre-locking groove and a locking groove; and the CPA device comprises protrusions engaging the pre-locking grooves of the pair of rails in the pre-locked position.

Optionally, moving the CPA device from the pre-locked position to the locked position comprises moving the protrusions from the pre-locking grooves to the locking grooves.

Optionally, each of the pair of elastic arms of the CPA devices a first interfacing portion and a second interfacing portion; the receptacle housing comprises a tongue portion; and the feature of the receptacle housing extends from the top wall of the receptacle housing towards the tongue portion of the receptacle housing.

Optionally, moving the CPA device from the pre-locked position to the locked position comprises moving the first interfacing portion of the pair of elastic arms to pass a bulge of a protruding portion of the plug housing; and abutting the second interfacing portions of the pair of elastic arms with the feature of the receptacle housing to spread the pair of elastic arms such that the CPA device can be moved to the locked position to prevent the hooks of the pair of resilient beams from disengaging from the apertures of the top wall of the receptacle housing.

Some embodiments relate to a high-stability interconnection system. The high-stability interconnection system may include a plug connector comprising a plug housing, a receptacle connector in a plug-in connection with the plug connector and comprising a receptacle housing connected to the plug housing, and a connector position assurance (CPA) device. A latch may be provided on an outside of the plug housing. There may be a space between the latch and the plug housing, and an aperture used for matching with the latch may be formed in a position on the receptacle housing corresponding to the latch. The CPA device may comprise a body slidably mounted in the space to lock the latch and two elastic arms disposed opposed to each other and formed by outer extensions of the body. The elastic arms may be formed thereon with first interfacing portions configured to abut the plug housing at a pre-locked position and second interfacing portions configured to abut the receptacle housing at a locked position.

Optionally, the body has protrusions formed on opposite sides thereof, and pre-locking grooves and locking grooves are provided on opposite sides of the plug housing corresponding to the space; and the pre-locking grooves and the locking grooves are disposed sequentially along a slide mounting direction of the body, and the protrusions are snapped into the pre-locking grooves or the locking grooves.

Optionally, the receptacle housing is provided, on both sides thereof, with sockets in plug-in connections with board locks, the board locks are symmetrically provided, on both sides thereof, with several barbs for enabling the board locks to be plugged in the sockets in an interference fit manner.

Optionally, portions of the board locks exposed out of the socket include bumps for enabling the board locks to be connected to the receptacle housing in an interference fit manner.

Optionally, the plug connector further comprises a flexible cable mounted to the plug housing, and the receptacle connector further comprises conductive elements mounted to the receptacle housing and electrically connected to the flexible cable.

Optionally, the receptacle housing includes a tongue portion, on which the conductive elements are arranged as and comprise an upper row of terminals and a lower row of terminals arranged in a misaligned arrangement in two rows with one positioned above the other.

Optionally, the upper row of terminals and the lower row of terminals both have dual-arm and dual-contact structures.

Optionally, the flexible cable includes holes on both sides thereof, and the plug housing is correspondingly provided there inside with elastic members for snapping into the holes; the plug connector further comprises an FPC/FFC position assurance (FPA) device for locking the flexible cable and snapping on the plug housing and abutting against the flexible cable.

Optionally, the plug housing includes several foolproof structures on an outer side thereof, and the receptacle housing is provided, at corresponding positions there inside, with guiding grooves for matching with the foolproof structures.

Optionally, the flexible cable includes a projection on one side thereof, and the plug housing is provided, at a corresponding position there inside, with a corner groove for matching with the projection.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a perspective view of a high-stability interconnection system, showing a receptacle connector and a plug connector mated with each other, according to some embodiments.

FIG. 2A is a perspective view of the high-stability interconnection system of FIG. 1, showing the receptacle connector and the plug connector separated from each other, and a connector position assurance (CPA) device exploded, with flexible cables, an FPC/FFC position assurance (FPA) device and a board lock of the receptacle connector hidden, showing a socket configured to receive the board lock.

FIG. 2B is a top view of the high-stability interconnection system of FIG. 2A, with the CPA device disposed in a pre-locked position.

FIG. 2C is a top view of the high-stability interconnection system of FIG. 1, with the CPA device disposed in the pre-locked position.

FIG. 2D is a vertical cross-sectional view of the high-stability interconnection system of FIG. 2C.

FIG. 2E is a top view of the high-stability interconnection system of FIG. 1, with the CPA device disposed in a locked position.

FIG. 2F is a vertical cross-sectional view of the high-stability interconnection system of FIG. 2E.

FIG. 3 is a perspective view of the CPA device shown in FIG. 2A.

FIG. 4A is a perspective view of the plug connector shown in FIG. 2A, with the CPA device exploded and flexible cables hidden.

FIG. 4B is a front perspective view of the plug connector of FIG. 4A.

FIG. 5 is a perspective view of a board lock of the receptacle connector shown in FIG. 1.

FIG. 6 is an exploded perspective view of the high-stability interconnection system of FIG. 1.

FIG. 7A is a front view of the receptacle connector shown in FIG. 2A.

FIG. 7B is a rear perspective view of the receptacle connector of FIG. 7A.

FIG. 7C is a vertical cross-sectional view of the receptacle connector of FIG. 7A.

FIG. 7D is a front perspective view of the receptacle connector of FIG. 7A.

FIG. 8A is a vertical cross-sectional view of the plug connector of FIG. 1.

FIG. 8B is a horizontal cross-sectional view of the plug connector of FIG. 1.

FIG. 9A is a front view of the receptacle connector of FIG. 7A.

FIG. 9B is a vertical cross-sectional view of the high-stability interconnection system of FIG. 1.

FIG. 9C is a horizontal cross-sectional view of the high-stability interconnection system of FIG. 1.

FIG. 10 is a horizontal cross-sectional view of the plug connector shown in FIG. 2A.

### DETAILED DESCRIPTION

The inventors have recognized and appreciated techniques for making high-stability connectors and interconnection systems for use in a harsh environment such as one presented by an automobile. For example, the connector may be used to connect a battery management system (BMS) and cell sensing circuit (CSC) in automobiles. The connector may be compatible with related standards such as USCAR-2 and TC9.

According to aspects of the present disclosure, an interconnection system may include a receptacle connector configured for mounting on a circuit board, and a plug connector configured for mating with the receptacle connector. The plug connector may include a latch and a connector position assurance (CPA) device together configured to secure the plug connector to the receptacle connector. The latch may be configured to engage matching features of the receptacle connector. The CPA device may be configured to be movable to a locked position from a pre-locked position when the plug connector is properly mated with the receptacle connector. At the locked position, the CPA device may prevent the latch of the plug connector from disengaging from the receptacle connector. A force to the latch may be required to unlock the connectors. At the pre-locked position, the CPA device may be constrained to the pre-locked position by features of the plug housing. The techniques describe herein can enable factory pre-installation of the CPA devices, facilitate convenient field operation, and ensure reliable interconnections in a harsh environment, such as those presented by automobiles.

In some embodiments, the CPA device may include a body and elastic arms extending from the body front and configured to abut a feature of the receptacle connector. In some embodiments, each elastic arm of the CPA device may include a first interfacing portion configured to abut a feature of the plug connector at the pre-locked position, and a second interfacing portion configured to abut a feature of the receptacle connector at the locked position.

In some embodiments, the first interfacing portion may include a recess recessing in a mating direction. The feature of the plug connector may include a bulge of an elongated protruding portion of the plug housing. At the pre-locked position, the first interfacing portion may abut the bulge, which may prevent the CPA device from moving forward into the locked position.

In some embodiments, the second interfacing portion may include a protrusion protruding in a direction perpendicular to the mating direction. The feature of the receptacle connector may include a pillar extending from a top wall of the receptacle housing towards a tongue portion holding terminals therein. When the plug connector is properly inserted into the receptacle connector, the elastic arms of the CPA device may be spread by surfaces of the pillar and therefore disengage from the bulge of the protruding portion of the plug housing. The CPA device can then be moved into the locked position.

In some embodiments, the CPA device may include cantilevers connected to body sides and configured to engage a feature of the plug connector. In some embodiments, each cantilever can include opposite ends connected to a body side of the CPA device, and a protrusion protruding away from the CPA body and configured to engage the feature of the plug housing. In some embodiments, the feature of the plug housing may include a pre-locking groove and a locking groove. In some embodiments, the CPA device may be configured to be movable between the pre-locked position when engaging the pre-locking grooves and the locked position when engaging the locking grooves.

In some embodiments, a method of operating the CPA device for securing the plug connector to the receptacle connection can include providing the plug connector with the CPA device disposed in the pre-locked position on the plug housing. The method may include engaging the plug connector with the receptacle connector, which may include disposing hooks of resilient beams of the plug housing into apertures of the top wall of the receptacle housing. The method may include moving the CPA device from the pre-locked position to a locked position, which may include pressing the clastic arms of the CPA device against one or more features of the receptacle housing. In some embodiments, moving the CPA device from the pre-locked position to the locked position may include moving the first interfacing portions of the elastic arms to pass the bulge of the protruding portion of the plug housing, and abutting the second interfacing portions of the elastic arms with the feature of the receptacle housing to spread the elastic arms such that the CPA device can be moved to the locked position to prevent the hooks of resilient beams from disengaging from the apertures of the top wall of the receptacle housing.

In some embodiments, the plug connector may include a plurality of flexible cables. The plurality of flexible cables may include a flexible flat cable (FFC), and/or a flexible circuit board (FPC), which may be used to transfer signals and/or power between different PCBs or components on the same PCB. Each flexible cable may include a connecting end having a plurality of conductive contacts configured to contact with complementary contacts of a mating connector (e.g., a receptacle connector). The connecting ends of the plurality of flexible cables may be disposed in the plug housing.

In some embodiments, an FPC/FFC position assurance (FPA) device may be mounted to the plug housing and configured to hold first segments of the connecting ends of the flexible cables in the plug housing. The FPA device may be configured to move between a pre-locked position and a locked position. Such a configuration can enable the plug connector to be pre-locked before the plurality of flexible cables are disposed in the plug housing, and therefore reduce the risk of accidentally disengaging the FPA device when inserting the plurality of flexible cables.

In some embodiments, one or more latching beams (e.g., elastic members 115) may extend from a base portion of the plug housing into an accommodation space of the plug housing. The latching beams may be configured to hold second segments of the connecting ends of the flexible cables in the plug housing.

Techniques described herein can enable the connecting ends of the flexible cables to be disposed directly in the plug housing for establishing electrical connections with a mating electrical component (e.g., a receptacle connector). Techniques described herein can enable the plug connector to have a simpler structure and less manufacturing cost than conventional connectors that utilize crimped cables.

Some embodiments of the present application are described in detail below in conjunction with the accompanying drawings.

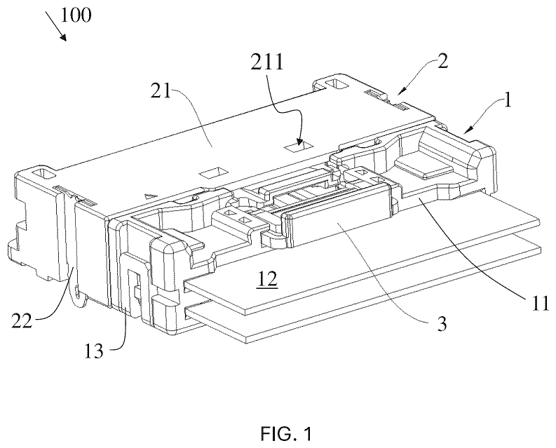

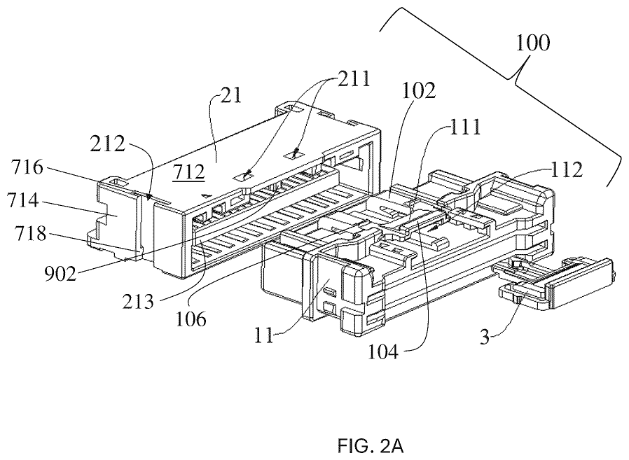

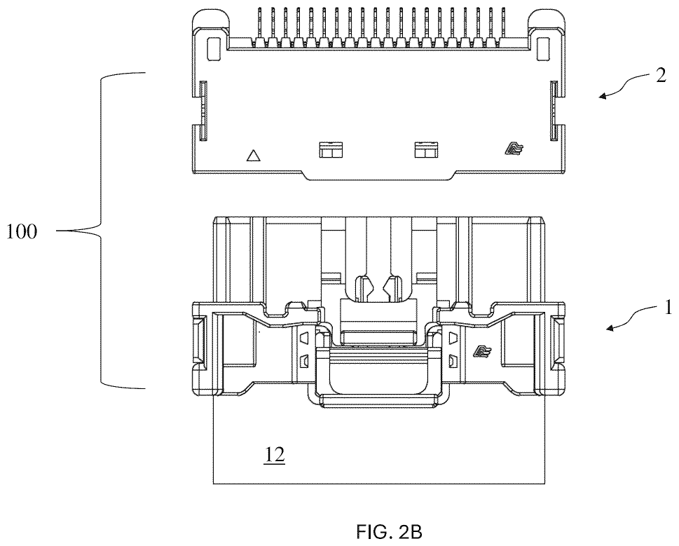

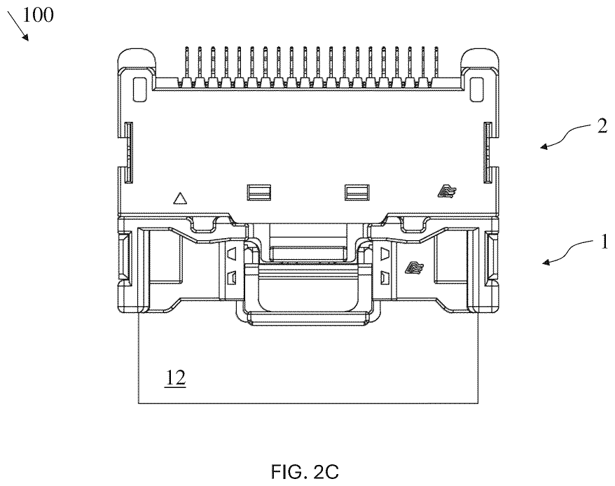

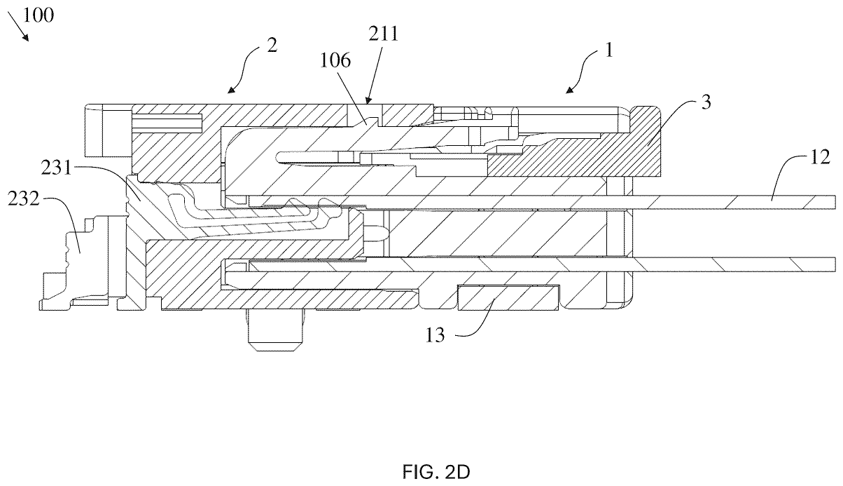

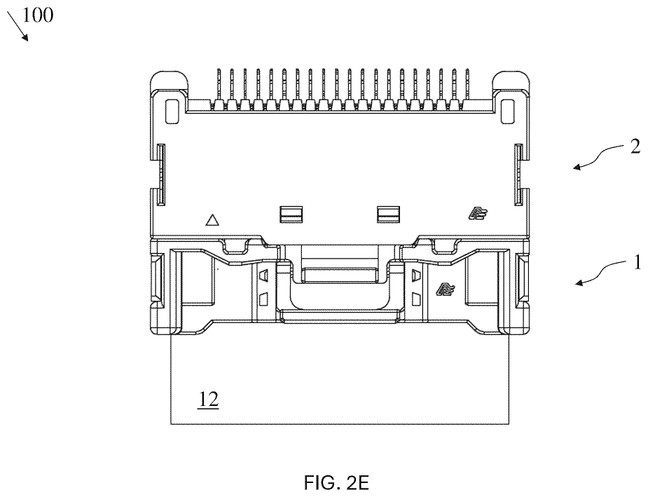

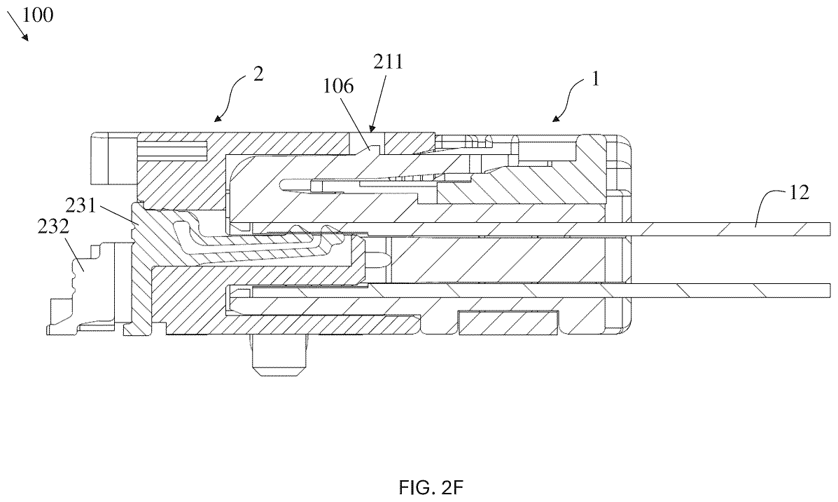

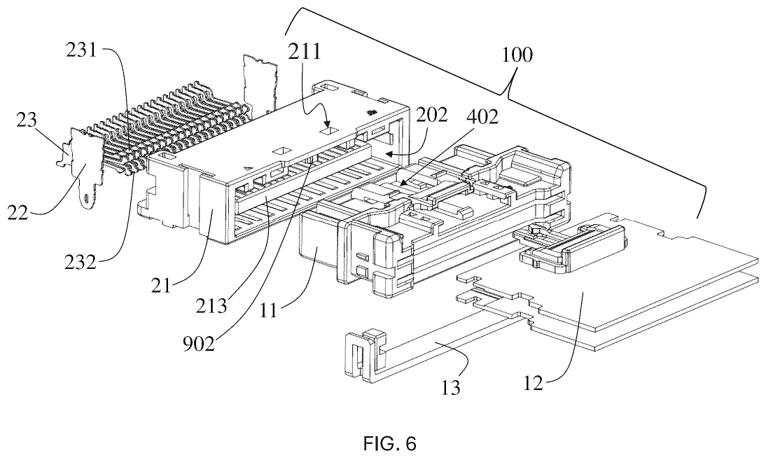

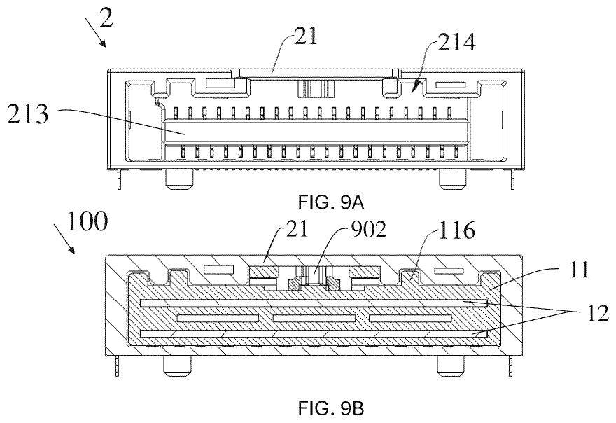

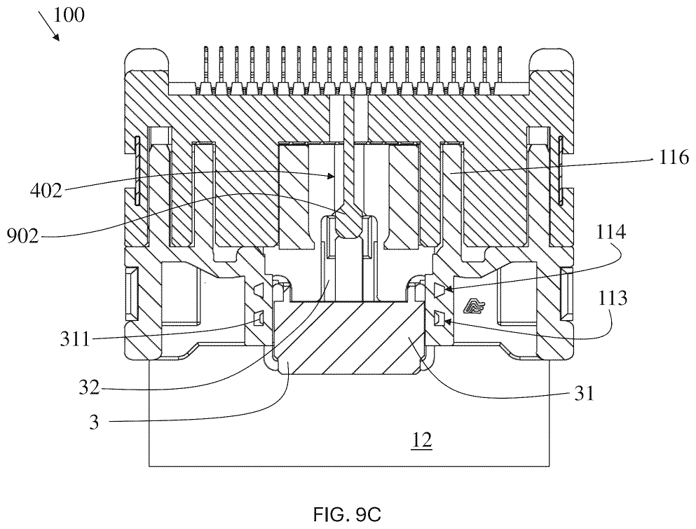

According to aspects of the present disclosure, FIG. 1 illustrates a high-stability interconnection system 100 comprising a plug connector 1 and a receptacle connector 2, shown as mated with each other. FIG. 9B is a vertical cross-sectional view of the high-stability interconnection system 1, along a mating interface between the plug connector 1 and the receptacle connector 2. FIG. 2A illustrates the high-stability interconnection system 100, showing the receptacle connector 2 and the plug connector 1 separated from each other, and a connector position assurance (CPA) device 3 exploded. FIG. 6 is an exploded perspective view of the high-stability interconnection system 100.

FIG. 2B is a top view of the high-stability interconnection system 100, with the CPA device 3 disposed in a pre-locked position. FIG. 2C is a top view of the high-stability interconnection system 100, with the CPA device 3 disposed in the pre-locked position. FIG. 2D is a vertical cross-sectional view of the high-stability interconnection system 100, with the CPA device disposed in the pre-locked position as shown in FIG. 2C. FIG. 9C is a horizontal cross-section view of the high-stability interconnection system 100, with the CPA device 3 disposed in the pre-locked position as shown in FIG. 2C. FIG. 2E is a top view of the high-stability interconnection system 100, with the CPA device 3 disposed in a locked position. FIG. 2F is a vertical cross-sectional view of the high-stability interconnection system 100, with the CPA device 3 disposed in the locked position as shown in FIG. 2E.

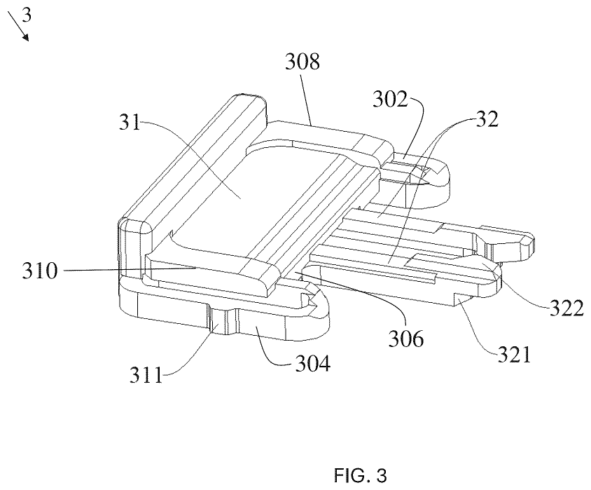

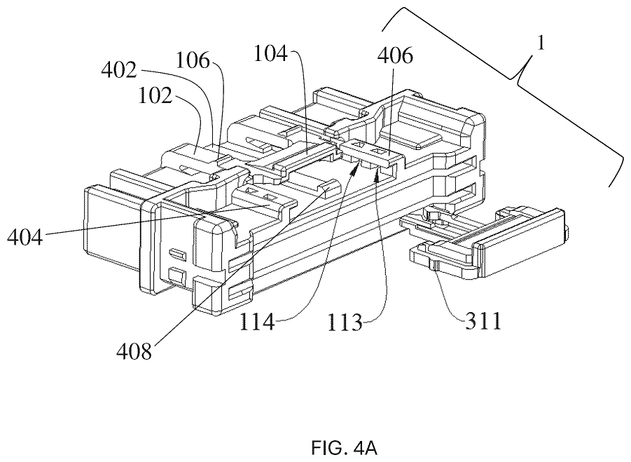

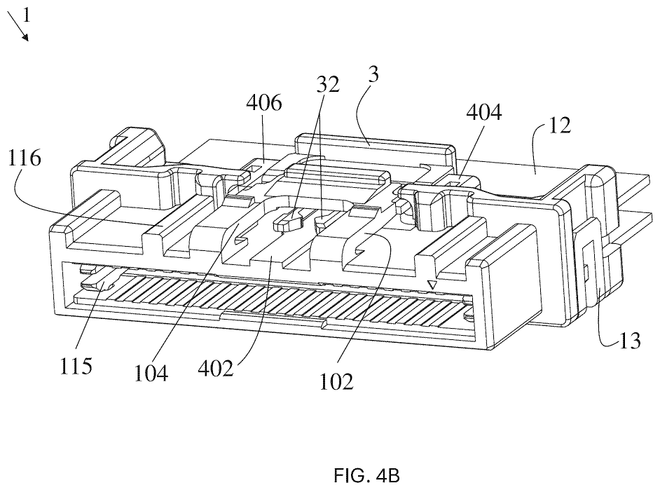

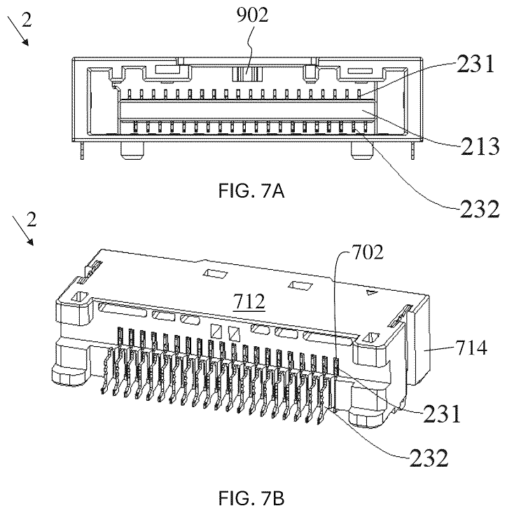

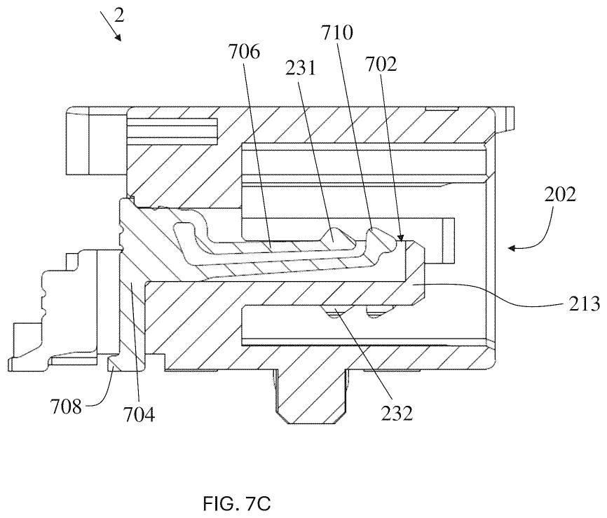

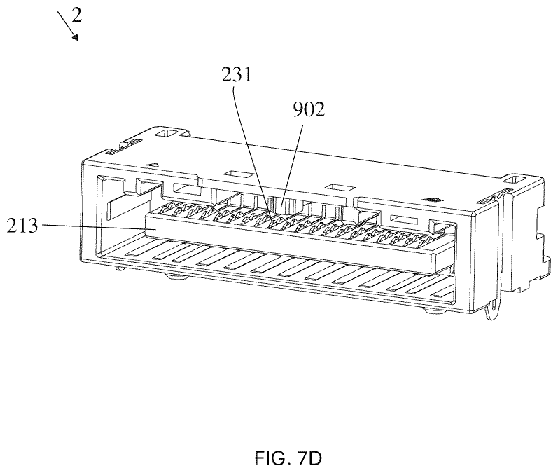

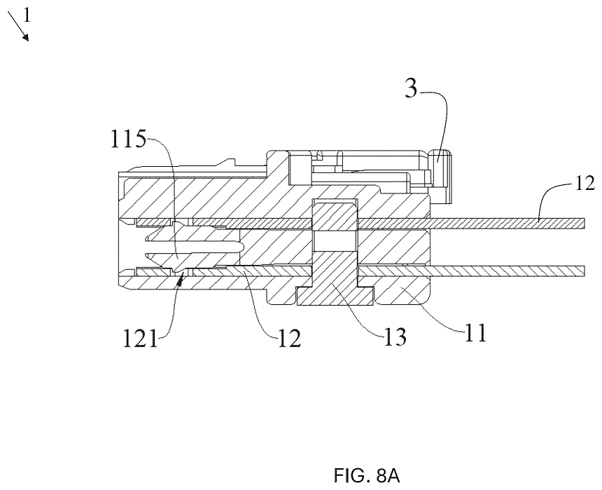

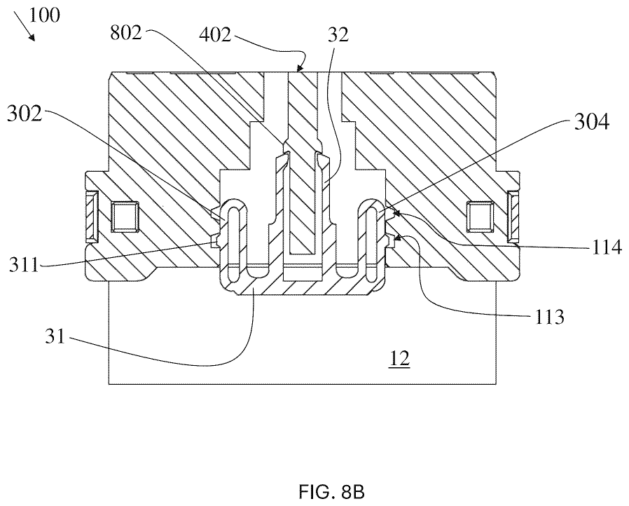

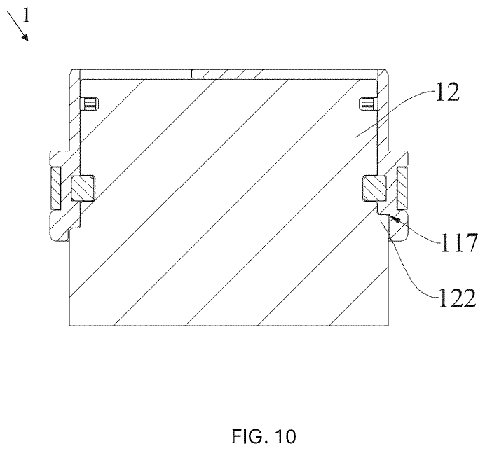

FIG. 3 illustrates the CPA device 3. FIG, 4A illustrates the plug connector 1, with the CPA device 3 exploded. FIG. 4B illustrate a front perspective view of the plug connector 1. FIG. 8A is a vertical cross-sectional views of the plug connector 1. FIG. 8B and FIG. 10 are horizontal cross-sectional views of the plug connector 1, along the CPA device 3 and a flexible cable, respectively. FIG. 7A and FIG. 9A illustrate front views of the receptacle connector 2. FIG. 7B is a rear perspective view of the receptacle connector 2. FIG. 7C is a vertical cross-sectional view of the receptacle connector 2. FIG. 7D is a front perspective view of the receptacle connector 2. The plug connector 1 may include a plug housing 11. The receptacle connector 2 may include a receptacle housing 21.

A latch 111 may be provided on an outer sidewall of the plug housing 11. In some embodiments, the latch 111 may includes two resilient beams 102 formed by outer extensions of the outer sidewall of the plug housing 11, and a bridge 104 connecting distal ends of the two resilient beams 102 and configured to be pressed to release the CPA device 3. As illustrated, there may be a space 112 between the latch 111 and the plug housing 11. Apertures 211 configured to mate with the latch 111 may be formed in positions on the receptacle housing 21 corresponding to the latch 111. In some embodiments, there may be a hook 106 formed on each of the two resilient beams 102 of the latch 111 and configured to be snapped into the aperture 211. A firm connection between the plug housing 11 and the receptacle housing 21 can be achieved by the cooperation of the latch 111 and the apertures 211, thereby preventing the plug housing 11 and the receptacle housing 21 from loosening in use and thus affecting the normal use of the connector.

Referring to FIG. 3, the CPA device 3 may include a body 31 slidably mounted in the space 112 to lock the latch 111, and two elastic arms 32 opposed and parallel to each other and each extending outwardly from the body 31. The CPA device 3 may include two cantilevers 302, 304 connected to opposite sides of the body 31, respectively. It should be appreciated that when in the locked position, as illustrated in FIG. 2F, the body 31 abuts against the bridge 104 of the latch 111 so as to restrict the latch 111 from bouncing, thereby avoiding abnormal bounce of the latch 111 in use from causing the latch 111 to fall out of the apertures 211 and resulting in the disengagement of the plug housing 11 and the receptacle housing 21, which would otherwise affect the normal use of the connector.

In some embodiments, each of the elastic arms 32 may include, at an end thereof, a first interfacing portion 321, which is configured to abut the plug housing 11 at the pre-locked position, and a second interfacing portion 322, which is positioned above the first interfacing portion 321 and configured to abut the receptacle housing 21 at the locked position. The first interfacing portion 321 may be a recess recessing in a mating direction of a mating receptacle connector. The second interfacing portion 322 may be a protrusion protruding in a direction perpendicular to the mating direction. In some embodiments, the two first interfacing portions 321 disposed respectively on the two elastic arms 32 may include two recesses disposed to be opposed to each other, and a bulge 802 may be correspondingly provided on the plug housing 11. As shown in FIG. 8B. when in the pre-locked position, the recesses may abut the bulge 802. When in the locked position, the hooks may abut the first feature(s) 902. The two second interfacing portion 322 may include two protrusions disposed to be opposed to each other, and a pillar 902 may be correspondingly provided on the receptacle housing 21. As shown in FIG. 9C, when in the locked position, the protrusions may abut the pillar 902. In some embodiments, the first interfacing portion 321 and the second interfacing portion 322 may be in a positional relationship in which they are misaligned with one stacked on the top of the other.

In some embodiments, for the CPA device 3 with the two elastic arms 32, the first interfacing portions 321 and the second interfacing portions 322 may first pass through the space 112 and be in plug-in connection with the plug housing 11 and the receptacle housing 21, respectively. The body 31 may slide into the space 112 and abut against the bridge 104 of the latch 111 to achieve the locking. With the arrangements of the elastic arms 32, the installation process can be smoother, and more importantly, the elastic arms 32 are connected to the plug housing 11 and the receptacle housing 21 at the same time, which not only achieves the fixation of the CPA device 3, but also further consolidates the connection relationship between the plug housing 11 and the receptacle housing 21, thereby effectively improving the overall connection stability of the connector.

In some embodiments, protrusions 311 may be formed on opposite sides of the body 31, and pre-locking grooves 113 and locking grooves 114 may be provided on opposite sides of the corresponding space 112 on the plug housing 11. In some embodiments, the plug housing may include rails 404, 406 disposed on opposite sides of the latch 111, and an elongated protruding portion 402 disposed between the resilient beams 102 and configured to be disposed below the feature 902 of the receptacle connector 2. The elongated protruding portion 402 may include a bulge 802 configured to abut against the elastic arms 32 of the CPA device 3 at the pre-locked position, and a hook 408 configured to engage the body 31 of the CPA device 3 at the pre-locked position. Each of the rails 404, 406 may include a pre-locking groove 113 and a locking groove 114. The pre-locking grooves 113 and the locking grooves 114 may be sequentially disposed along a sliding installation direction of the body 31, and the protrusions 311 may be snapped into the pre-locking grooves 113 or the locking grooves 114. As shown in FIG. 2C and FIG. 2D, when the protrusions 311 are snapped into the pre-locking grooves 113, the body 31 may not abut against the latch 111 and the latch 111 is in a pre-locked position, thus the plug connector 1 can be plugged-out of the receptacle connector 2. As shown in FIG. 2E and 2F, when the protrusions 311 are snapped into the locking grooves 114, the body 31 may abut against the latch 111 and the latch 111 is in a locked position, thus the plug connector 1 is locked to the receptacle connector 2. Through moving the protrusions 311 into the pre-locking grooves 113 or the locking grooves 114, the unlocking and locking of the latch 111 by the CPA device 3 can be achieved, which is simple and convenient to operate, and is robust.

In some embodiments, the pre-locking grooves 113 and the locking grooves 114 are visible grooves, which facilitate confirming the snap-in state of the protrusions 311, thereby ensuring that the CPA device 3 can be sufficiently unlocked and locked. It should be noted that since the unlocking and locking of the latch 111 can be achieved by sliding the protrusions 311 into the pre-locking grooves 113 or the locking grooves 114, the CPA device 3 can be connected to the receptacle housing 11 all the time in use without repeated removal and installation, which improves the case of use of the connector.

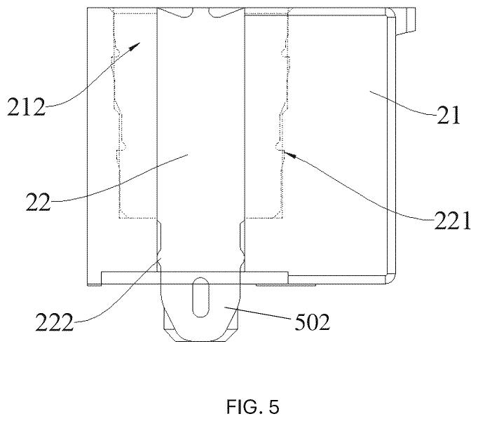

FIG. 5 illustrates a board lock 22 of the receptacle connector 2. Sockets 212 may be provided on opposite sides of the receptacle housing 21, plugged in each of which is a board lock 22 configured to connect the receptacle housing 21 and a circuit board. Each board lock 22 may include a contact tail 502 extending beyond the respective socket 212. Both sides of the board lock 22 are symmetrically provided with several barbs 221 for enabling the board lock 22 to be plugged in the socket 212 in an interference fit manner. In some embodiments, both sides of the board lock 22 are symmetrically provided with barbs 221, with two barbs on each side. The barbs 221 may engage inner walls 718 of the respective socket 212. The interference fit of the barbs 221 with the socket 212 can increase the retention force for the board lock 22, so as to more securely connect the board lock 22 to the receptacle housing 21.

In some embodiments, a portion of the board lock 22 exposed out of the socket 212 may include a bump 222 for enabling the board lock 22 to be connected to the receptacle housing 21 in an interference fit manner. The bump 222 may be adjacent the contact tail 502 of the board lock 22 and engage outer walls 716 of the respective socket 212. It should be appreciated that the socket 212 is provided along a height direction of the receptacle housing 21 and does not pass through the entire height thereof, so that when the board lock 22 is plugged into the socket 212, the portion of the board lock 22 extending out of the socket 212 abuts directly against the receptacle housing 21. In some embodiments, the bumps 222 may be provided on opposite sides of the portion of the board lock 22 extending out of the socket 212, and are connected to the receptacle housing 21 in an interference fit manner. With the interference fit between the bumps 222 and the receptacle housing 21, the relative position between the receptacle housing 21 and the circuit board can be more precise and fixed, effectively reducing the degree of positional deviation of the receptacle housing 21 on the circuit board, and further improving the connection stability of the connector.

The high-stability interconnection system strengthens the connection relationship between the plug housing and the receptacle housing by providing elastic arms on the CPA device, thereby improving the connection stability of the connector; improves the ease of use of the connector through the switching cooperation of the protrusions with the pre-locking grooves and the locking grooves; increases the retention force of the board lock on the receptacle housing by providing barbs on the board lock, thereby improving the connection stability between the connector and the circuit board; and reduces the deflection of the connector by providing bumps on the board lock, thereby further improving the overall connection stability of the connector.

The receptacle connector 2 may include conductive elements 23 mounted to the receptacle housing 21. The plug connector 1 may include a flexible cable 12 mounted to the plug housing 11 and electrically connected with the conductive elements 23. In some embodiments, the flexible cable 12 includes a plurality of contact strips, each of which is electrically connected to a corresponding conductive element 23.

In some embodiments, a tongue portion 213 is formed in a slot 202 of the receptacle housing 21, and separate the slot 202 into an upper portion and a lower portion. The conductive elements 23 may include an upper row of terminals 231 and a lower row of terminals 232 arranged in two rows which are positioned one above the other, and the terminals of each of the upper row 231 and the lower row 232 are arranged in equal spacing. The upper row of terminals 231 and the lower row of terminals 232 may be both mounted on the tongue portion 213, and be arranged in a misaligned manner.

In some embodiments, each conductive element 23 may include a base portion 704 held by the receptacle housing 21, a mating beam 706 extending from the base portion 704 into a respective chamber 702 of the tongue portion 213, and a contact tail 708 extending from the base portion 704. The terminals 231 and the terminals 232 may be disposed in alternative. Each first terminal 231 may include two mating contact portions 710 protruding into the upper portion of the slot 202. Each second terminal 231 may include two mating contact portions 710 protruding into the lower portion of the slot 202.

In some embodiments, contact ends of the upper row of terminals 231 and those of the lower row of terminals 232 are arranged one above the other in a misaligned manner, and weld ends of the upper row of terminals 231 and those of the lower row of terminals 232 are arranged one ahead of the other in a misaligned manner. With such a misaligned arrangement of the terminals, the volume of the connector can be significantly reduced, thereby reducing the cost of raw materials and improving the flexibility of the connector.

In some embodiments, the upper row of terminals 231 and the lower row of terminals 232 both have a dual-arm and dual-contact structure. The use of such a structure can improve the transmission efficiency of the connector and, at the same time, improve the contact stability.

Holes 121 may be provided on both sides of the flexible cable 12, and elastic members 115 are correspondingly provided inside the plug housing 11 to be in snapping connections with the holes 121. In order to further lock the flexible cable 12 and prevent the flexible cable 12 from loosening, the plug connector 1 is further provided with an FPC/FFC position assurance (FPA) device 13 which is used for locking the flexible cable 12. The FPA device 13 snaps onto the plug housing 11 and abuts against the flexible cable 12. When installed, the flexible cable 12 is plugged into the plug housing 11, and the holes 121 are in snapping connections with the elastic members 115, so as to restrict the movement of the flexible cable 12 in a horizontal direction, thereby achieving an initial locking of the flexible cable 12. With the snap-fit mounting of the FPA device 13 along a vertical direction, the movement of the flexible cable 12 in the vertical direction is restricted and a secondary locking of the flexible cable 12 is achieved, thereby improving the connection stability of the flexible cable 12 to the plug housing 11.

In some embodiments, the FPA device 13 may be pre-locked on the plug housing 11 in the factory, and the user, when conducting installation, only needs to plug the flexible cables 12 into the plug housing 11 so that the elastic members 115 are snapped into the holes 121, and the FPA device is then pressed to be snap-fitted to the plug housing 11. The installation process is simple, convenient, and easy-to-operate.

The high-stability interconnection system reduces the volume of the connector, reduces the cost of raw materials, and improves the flexibility of the connector via the misaligned arrangement of the upper row of terminals and the lower row of terminals; improves the contact stability and transmission efficiency via the dual-arm and dual-contact structure of the upper and lower rows of terminals; achieves the initial locking of the flexible cable via the cooperation of the elastic members and the holes, and achieves the secondary locking of the flexible cable via the snap-fit fixation of the FPA device, thereby improving the connection stability of the connector.

The plug housing 11 may include several foolproof structures 116 on the outer side thereof, and the receptacle housing 21 is provided, at corresponding positions there inside, with guiding grooves 214 for matching with the foolproof structures 116. The foolproof structures 116 may be provided on the side of the plug housing 11 opposite to the latch 111. In some embodiments, the foolproof structures 116 and the guiding grooves 214 are both two in number, and with a center line of the plug housing 11 as a reference, the two foolproof structures 116 may be symmetrically disposed near the center line, or symmetrically disposed away from the center line, or asymmetrically disposed, for example, with one being near the center line and the other being away therefrom.

In some embodiments, operation positions may also be provided on opposite sides of the exterior of the plug housing 11 to facilitate plugging and unplugging operation of the plug housing 11 by hand, thereby improving the case of operation of the connector in use.

The flexible cable 12 may include a projection 122 on one side thereof, and the plug housing 11 is provided, at a corresponding position there inside, with a corner groove 117 configured to match with the projection 122. It should be appreciated that, since the flexible cable 12 may include the projection 122 on one side thereof, the flexible cable 12 has asymmetric structures on both sides thereof, thus facilitating identification of the insertion direction of the flexible cable 12 and preventing a reverse plug-in connection of the flexible cable 12, which will otherwise prevent the flexible cable 12 from being normal contact with the conductive elements 23 and thus affect the normal use of the connector.

The high-stability interconnection system is capable of preventing a reverse plug-in connection of the plug housing and the receptacle housing via the cooperation between the foolproof structures and the guiding grooves, thereby improving the connection accuracy and high efficiency of the connector; and effectively prevents the reverse plug-in connection of the flexible cable via the cooperation between the projection and the corner groove, thereby ensuring the normal electrical connections between the flexible cable and the conductive elements, and thus the normal use of the connector.

Various aspects are described in this disclosure, which include, but are not limited to, the following aspects:
1. A high-stability interconnection system comprising a plug connector (e.g., 1) comprising a plug housing (e.g., 11), a receptacle connector (e.g., 2) in a plug-in connection with the plug connector (e.g., 1) and comprising a receptacle housing (e.g., 21) connected to the plug housing (e.g., 11), and a connector position assurance (CPA) device (e.g., 3), wherein a latch (e.g., 111) is provided on an outside of the plug housing (e.g., 11), there is a space (e.g., 112) between the latch (e.g., 111) and the plug housing (e.g., 11), and an aperture (e.g., 211) used for matching with the latch (e.g., 111) is formed in a position on the receptacle housing (e.g., 21) corresponding to the latch (e.g., 111); wherein the CPA device (e.g., 3) comprises a body (e.g., 31) slidably mounted in the space (e.g., 112) to lock the latch (e.g., 111) and two elastic arms (e.g., 32) disposed opposed to each other and formed by outer extensions of the body (e.g., 31); wherein the elastic arms (e.g., 32) are formed thereon with first interfacing portions (e.g., 321) configured to abut the plug housing (e.g., 11) at a pre-locked position and second interfacing portions (e.g., 322) configured to abut the receptacle housing (e.g., 21) at a locked position.
2. The high-stability interconnection system of aspect 1, wherein the body (e.g., 31) has protrusions (e.g., 311) formed on opposite sides thereof, and pre-locking grooves (e.g., 113) and locking grooves (e.g., 114) are provided on opposite sides of the plug housing (e.g., 11) corresponding to the space (e.g., 112); and the pre-locking grooves (e.g., 113) and the locking grooves (e.g., 114) are disposed sequentially along a slide mounting direction of the body (e.g., 31), and the protrusions (e.g., 311) are snapped into the pre-locking grooves (e.g., 113) or the locking grooves (e.g., 114).
3. The high-stability interconnection system of aspect 1, wherein the receptacle housing (e.g., 21) is provided, on both sides thereof, with sockets (e.g., 212) in plug-in connections with board locks (e.g., 22), the board locks (e.g., 22) are symmetrically provided, on both sides thereof, with several barbs (e.g., 221) for enabling the board locks (e.g., 22) to be plugged in the sockets (e.g., 212) in an interference fit manner.
4. The high-stability interconnection system of aspect 3, wherein portions of the board locks (e.g., 22) exposed out of the socket (e.g., 212) include bumps (e.g., 222) for enabling the board locks (e.g., 22) to be connected to the receptacle housing (e.g., 21) in an interference fit manner.
5. The high-stability interconnection system of aspect 1, wherein the plug connector (e.g., 1) further comprises a flexible cable (e.g., 12) mounted to the plug housing (e.g., 11), and the receptacle connector (e.g., 2) further comprises conductive elements (e.g., 23) mounted to the receptacle housing (e.g., 21) and electrically connected to the flexible cable (e.g., 12).
6. The high-stability interconnection system of aspect 5, wherein the receptacle housing (e.g., 21) includes a tongue portion (e.g., 213), on which the conductive elements (e.g., 23) are arranged and comprise an upper row of terminals (e.g., 231) and a lower row of terminals (e.g., 232) arranged in a misaligned arrangement in two rows with one positioned above the other.
7. The high-stability interconnection system of aspect 6, wherein the upper row of terminals (e.g., 231) and the lower row of terminals (e.g., 232) both have dual-arm and dual-contact structures.
8. The high-stability interconnection system of aspect 5, wherein the flexible cable (e.g., 12) includes holes (e.g., 121) on both sides thereof, and the plug housing (e.g., 11) is correspondingly provided there inside with elastic members (e.g., 115) for snapping into the holes (e.g., 121); and the plug connector (e.g., 1) further comprises an FPC/FFC position assurance (FPA) device (e.g., 13) for locking the flexible cable (e.g., 12) and snapping on the plug housing (e.g., 11) and abutting against the flexible cable (e.g., 12).
9. The high-stability interconnection system of aspect 1, wherein the plug housing (e.g., 11) includes several foolproof structures (e.g., 116) on an outer side thereof, and the receptacle housing (e.g., 21) is provided, at corresponding positions there inside, with guiding grooves (e.g., 214) for matching with the foolproof structures (e.g., 116).
10. The high-stability interconnection system of aspect 5, wherein the flexible cable (e.g., 12) includes a projection (e.g., 122) on one side thereof, and the plug housing (e.g., 11) is provided, at a corresponding position there inside, with a corner groove (e.g., 117) for matching with the projection (e.g., 122).
11. A connector position assurance (CPA) device (e.g., 3) for a plug connector (e.g., 1), comprising a body (e.g., 31) comprising first and second sides (e.g., 308, 310) opposite to each other, and a front (e.g., 306) joining the first and second sides; first and second cantilevers (e.g., 302, 304) connected to the first and second sides of the body, respectively, the first and second cantilevers configured to engage a first feature (e.g., 113, 114) of the plug connector; and first and second elastic arms (e.g., 32) extending from the front of the body and configured to abut a feature (e.g., 902) of a mating receptacle connector (e.g., 2) to the plug connector such that the CPA device prevents a latch (e.g., 111) of the plug connector from disengaging from the mating receptacle connector,
12. The CPA device of aspect 11, wherein each of the first and second elastic arms comprises a first interfacing portion (e.g., 321) configured to abut a second feature (e.g., 802) of the plug connector at a pre-locked position, and a second interfacing portion (e.g., 322) configured to abut the feature of the mating receptacle connector at a locked position.
13. The CPA device of aspect 12, wherein, for each of the first and second elastic arms: the first interfacing portion (e.g., 321) is a recess recessing in a mating direction; and the second interfacing portion (e.g., 322) is a protrusion protruding in a direction perpendicular to the mating direction.

14. The CPA device of aspect 11, wherein the first cantilever (e.g., 302) comprises first and second ends respectively connected to the first side of the body; the second cantilever (e.g., 304) comprises third and fourth ends respectively connected to the second side of the body; and each of the first and second cantilevers comprises a protrusion (e.g., 311) protruding away from the body and configured to engage the first feature of the plug connector.
15. A plug connector for terminating first and second flexible cables (e.g., 12), comprising a housing (e.g., 11) comprising first and second rails (e.g., 404, 406), and the latch disposed between the first and second rails, each of the first and second rails comprising a pre-locking groove (e.g., 113) and a locking groove (e.g., 114); and the CPA device described herein, the CPA device configured to be movable between a pre-locked position when engaging the pre-locking grooves of the first and second rails of the housing and a locked position when engaging the locking grooves of the locking grooves of the first and second rails of the housing.
16. The plug connector of aspect 15, wherein the latch comprises first and second resilient beams (e.g., 102) and a bridge (e.g., 104) connecting distal ends of the first and second resilient beams; and the CPA device is configured to abut against the bridge of the latch of the housing in the locked position.
17. The plug connector of aspect 16, wherein the housing comprises a protruding portion (e.g., 402) disposed between the first and second resilient beams of the latch of the housing and configured to be disposed below the feature of the mating receptacle connector.
18. The plug connector of aspect 17, wherein the protruding portion comprises a bulge (e.g., 802) configured to abut against the first and second elastic arms of the CPA device at the pre-locked position, and a hook (e.g., 408) configured to engage the body of the CPA device at the pre-locked position.
19. The plug connector of aspect 17, wherein each of the first and second elastic arms of the CPA device comprises an interfacing portion (e.g., 321, 322) disposed adjacent the protruding portion of the housing.
20. The plug connector of aspect 15, wherein the first and second flexible cables comprise a flexible flat cable (FFC), and/or a flexible circuit board (FPC); and the housing comprises elastic members (e.g., 115) configured to snap into holes (e.g., 121) of the first and second flexible cables to pre-lock the first and second flexible cables.
21. A receptacle connector (e.g., 2) comprising a housing (e.g., 21) comprising a slot (e.g., 202), a tongue portion (e.g., 213) disposed in the slot and separating the slot into an upper portion and a lower portion, and a feature (e.g., 902) disposed in the upper portion of the slot, the tongue portion comprising a plurality of chambers (e.g., 702); and a plurality of conductive elements (e.g., 23), each of the plurality of conductive elements comprising a base portion (e.g., 704) held by the housing, a mating beam (e.g., 706) extending from the base portion into a respective chamber of the tongue portion, and a contact tail (e.g., 708) extending from the base portion, the plurality of conductive elements comprising first terminals (e.g., 231) and second terminals (e.g., 232) disposed in alternative, each of the first terminals comprising two mating contact portions (e.g., 710) protruding into the upper portion of the slot, and each of the second terminals comprising two mating contact portions protruding into the lower portion of the slot.
22. The receptacle connector of aspect 21, wherein the feature is a pillar extending from a top wall (e.g., 712) of the housing towards the tongue portion of the housing.
23. The receptacle connector of aspect 22, wherein the top wall of the housing comprises first and second apertures (e.g., 211) disposed on opposite sides of the pillar and configured to engage hooks (e.g., 106) of a mating plug connector.
24. The receptacle connector of aspect 22, wherein the housing comprises first and second side walls (e.g., 714) connected by the top wall; each of the first and second side walls comprises a socket (e.g., 212); and the receptacle connector comprises first and second board locks (e.g., 22) each disposed in the socket of a respective one of the first and second side walls of the housing.
25. The receptacle connector of aspect 24, wherein each of the first and second board locks comprises a contact tail (e.g., 502) extending beyond the respective socket; a bump (e.g., 222) adjacent the contact tail and engaging outer walls (e.g., 716) of the respective socket, and a plurality of barbs (e.g., 221) engaging inner walls (e.g., 718) of the respective socket.
26. A method of operating a connector position assurance (CPA) device (e.g., 3) for securing a plug connector (e.g., 1) to a receptacle connector (e.g., 2), the method comprising providing the plug connector with the CPA device disposed in a pre-locked position on a plug housing (e.g., 11), the plug housing comprising a latch (e.g., 111) with a pair of resilient beams (e.g., 102) and a bridge (e.g., 104) connecting distal ends of the pair of resilient beams, each of the pair of resilient beams comprising a hook (e.g., 106) protruding upwards; engaging the plug connector with the receptacle connector comprising disposing the hooks of the pair of resilient beams into apertures (e.g., 211) of a top wall (e.g., 712) of a receptacle housing; and moving the CPA device from the pre-locked position to a locked position comprising pressing a pair of elastic arms (e.g., 32) of the CPA device against a feature (e.g., 902) of the receptacle housing.
27. The method of aspect 26, wherein the plug housing comprises a pair of rails (e.g., 404, 406) disposed on opposite sides of the latch; each of the pair of rails comprises a pre-locking groove (e.g., 113) and a locking groove (e.g., 114); and the CPA device comprises protrusions (e.g., 311) engaging the pre-locking grooves of the pair of rails in the pre-locked position.
28. The method of aspect 27, wherein moving the CPA device from the pre-locked position to the locked position comprises moving the protrusions from the pre-locking grooves to the locking grooves.
29. The method of aspect 26, wherein each of the pair of elastic arms of the CPA devices a first interfacing portion (e.g., 321) and a second interfacing portion (e.g., 322); the receptacle housing comprises a tongue portion (e.g., 213); and the feature (e.g., 902) of the receptacle housing extends from the top wall of the receptacle housing towards the tongue portion of the receptacle housing.
30. The method of aspect 29, wherein moving the CPA device from the pre-locked position to the locked position comprises moving the first interfacing portion (e.g., 321) of the pair of elastic arms to pass a bulge (e.g., 802) of a protruding portion (e.g., 402) of the plug housing; and abutting the second interfacing portions (e.g., 322) of the pair of elastic arms with the feature (e.g., 902) of the receptacle housing to spread the pair of elastic arms such that the CPA device can be moved to the locked position to prevent the hooks of the pair of resilient beams from disengaging from the apertures of the top wall of the receptacle housing.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear,” “upper,” “lower,” “left,” “right.” “transverse direction,” “vertical direction.” “perpendicular,” “horizontal,” “top,” “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on,” “above,” “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features.” Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of.” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also enables that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B.” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A connector position assurance (CPA) device for a plug connector, comprising:
a body comprising first and second sides opposite to each other, and a front joining the first and second sides;
first and second cantilevers connected to the first and second sides of the body, respectively, the first and second cantilevers configured to engage a first feature of the plug connector; and
first and second elastic arms extending from the front of the body and configured to abut a feature of a mating receptacle connector to the plug connector such that the CPA device prevents a latch of the plug connector from disengaging from the mating receptacle connector.

2. The CPA device of claim 1, wherein:
each of the first and second elastic arms comprises a first interfacing portion configured to abut a second feature of the plug connector at a pre-locked position, and a second interfacing portion configured to abut the feature of the mating receptacle connector at a locked position.

3. The CPA device of claim 2, wherein, for each of the first and second elastic arms:
the first interfacing portion is a recess recessing in a mating direction; and
the second interfacing portion is a protrusion protruding in a direction perpendicular to the mating direction.

4. The CPA device of claim 1, wherein:
the first cantilever comprises first and second ends respectively connected to the first side of the body;
the second cantilever comprises third and fourth ends respectively connected to the second side of the body; and
each of the first and second cantilevers comprises a protrusion protruding away from the body and configured to engage the first feature of the plug connector.

5. A plug connector for terminating first and second flexible cables, comprising:
a housing comprising first and second rails, and the latch disposed between the first and second rails, each of the first and second rails comprising a pre-locking groove and a locking groove; and
the CPA device of claim 1, the CPA device configured to be movable between a pre-locked position when engaging the pre-locking grooves of the first and second rails of the housing and a locked position when engaging the locking grooves of the locking grooves of the first and second rails of the housing.

6. The plug connector of claim 5, wherein:
the latch comprises first and second resilient beams and a bridge connecting distal ends of the first and second resilient beams; and
the CPA device is configured to abut against the bridge of the latch of the housing in the locked position.

7. The plug connector of claim 6, wherein:
the housing comprises a protruding portion disposed between the first and second resilient beams of the latch of the housing and configured to be disposed below the feature of the mating receptacle connector.

8. The plug connector of claim 7, wherein:
the protruding portion comprises a bulge configured to abut against the first and second elastic arms of the CPA device at the pre-locked position, and a hook configured to engage the body of the CPA device at the pre-locked position.

9. The plug connector of claim 7, wherein:
each of the first and second elastic arms of the CPA device comprises an interfacing portion disposed adjacent the protruding portion of the housing.

10. The plug connector of claim 5, wherein:
the first and second flexible cables comprise a flexible flat cable (FFC), and/or a flexible circuit board (FPC); and
the housing comprises elastic members configured to snap into holes of the first and second flexible cables to pre-lock the first and second flexible cables.

11. A receptacle connector comprising:
a housing comprising a slot, a tongue portion disposed in the slot and separating the slot into an upper portion and a lower portion, and a feature disposed in the upper portion of the slot, the tongue portion comprising a plurality of chambers; and
a plurality of conductive elements, each of the plurality of conductive elements comprising a base portion held by the housing, a mating beam extending from the base portion into a respective chamber of the tongue portion, and a contact tail extending from the base portion, the plurality of conductive elements comprising first terminals and second terminals disposed in alternative, each of the first terminals comprising two mating contact portions protruding into the upper portion of the slot, and each of the second terminals comprising two mating contact portions protruding into the lower portion of the slot.

12. The receptacle connector of claim 11, wherein:
the feature is a pillar extending from a top wall of the housing towards the tongue portion of the housing.

13. The receptacle connector of claim 12, wherein:
the top wall of the housing comprises first and second apertures disposed on opposite sides of the pillar and configured to engage hooks of a mating plug connector.

14. The receptacle connector of claim 12, wherein:
the housing comprises first and second side walls connected by the top wall;
each of the first and second side walls comprises a socket; and
the receptacle connector comprises first and second board locks each disposed in the socket of a respective one of the first and second side walls of the housing.

15. The receptacle connector of claim 14, wherein each of the first and second board locks comprises:
a contact tail extending beyond the respective socket;
a bump adjacent the contact tail and engaging outer walls of the respective socket; and
a plurality of barbs engaging inner walls of the respective socket.

16. A method of operating a connector position assurance (CPA) device for securing a plug connector to a receptacle connector, the method comprising:
providing the plug connector with the CPA device disposed in a pre-locked position on a plug housing, the plug housing comprising a latch with a pair of resilient beams and a bridge connecting distal ends of the pair of resilient beams, each of the pair of resilient beams comprising a hook protruding upwards;
engaging the plug connector with the receptacle connector comprising disposing the hooks of the pair of resilient beams into apertures of a top wall of a receptacle housing; and
moving the CPA device from the pre-locked position to a locked position comprising pressing a pair of elastic arms of the CPA device against a feature of the receptacle housing.

17. The method of claim 16, wherein:
the plug housing comprises a pair of rails disposed on opposite sides of the latch;
each of the pair of rails comprises a pre-locking groove and a locking groove; and
the CPA device comprises protrusions engaging the pre-locking grooves of the pair of rails in the pre-locked position.

18. The method of claim 17, wherein:
moving the CPA device from the pre-locked position to the locked position comprises moving the protrusions from the pre-locking grooves to the locking grooves.

19. The method of claim 16, wherein:
each of the pair of elastic arms of the CPA devices a first interfacing portion and a second interfacing portion;
the receptacle housing comprises a tongue portion; and
the feature of the receptacle housing extends from the top wall of the receptacle housing towards the tongue portion of the receptacle housing.

20. The method of claim 19, wherein moving the CPA device from the pre-locked position to the locked position comprises:
moving the first interfacing portion of the pair of elastic arms to pass a bulge of a protruding portion of the plug housing; and
abutting the second interfacing portions of the pair of elastic arms with the feature of the receptacle housing to spread the pair of elastic arms such that the CPA device can be moved to the locked position to prevent the hooks of the pair of resilient beams from disengaging from the apertures of the top wall of the receptacle housing.
